(19) United States
(12) Patent Application Publication
(10) Pub. No.: US 2005/0111919 A1
(43) Pub. Date: May 26, 2005

(54) Method and apparatus for underground pipeline installation

(76) Inventors: Steven W. Wentworth, Brookfield, WI (US); Robert F. Crane, Oconomowoc, WI (US)

Correspondence Address: Philip G. Meyers;Philip G. Meyers Law Office, Suite 302, 1009 Long Prairie Road, Flower Mound, TX, 75022, US

(21) Appl. No.: 10/997,837

(22) Filed: Nov. 24, 2004

Related U.S. Application Data
(60) Provisional application No. 60/524,590, filed on Nov. 25, 2003.

(51) Int. Cl. F16L 55/16; E21D 1/06

(52) U.S. Cl. 405/184.3; 138/98; 138/99; 405/184

(57) ABSTRACT

A method according to the invention for installing an underground pipe uses a ground piercing tool having an elongated tubular tool body, a striker disposed for reciprocation within an internal chamber of the body to impart impacts to an impact surface for driving the tool forwardly through the ground, and an expander having a diameter greater than that of the tool body. The method includes the steps of securing a tubular shroud to the expander so that the ground piercing tool is disposed inside of the shroud, operating the tool in forward mode over a run so that the impact tool and shroud move forward, fitting a front end of a replacement pipe into sliding engagement with a rear end of the shroud, and pushing the replacement pipe from a rear end portion thereof in a manner sufficient to insure that a front end of the replacement pipe remains in sliding contact with the shroud as the tool moves forward.

This application claims priority of U.S. Provisional Patent Application Ser. No. 60/524,590, filed Nov. 25, 2003.

### FIELD OF THE INVENTION

The present invention relates to underground pipe bursting and replacement, especially using a pneumatic impact tool.

### BACKGROUND OF THE INVENTION

The method of installing pipe through a process known as pipe bursting is well known in the industry (see Streatfield et al U.S. Pat. Nos. 4,738,565; 4,720,211; 4,505,302). The host pipe may be any that is frangible in nature. These host pipes (pipe that is already in the ground) are very suitable for fracture with a pneumatic impact device such as the Hammerhead Mole®. Further, it is common for manufacturers of these pneumatic devices to teach the method outlined in Wentworth (U.S. Pat. No. 6,299,382) of Manhole Extraction without Excavation, hereafter MEw/oE.

The new pipe, most often referred to as the product pipe, is widely preferred to be HDPE (High Density Poly Ethylene). It is normally attached to the burst head and is therefore subject to the shock and high acceleration induced by the operation of a pneumatic impact tool. This material, HDPE, is well suited for that shock loading due to its elastic properties. Unfortunately, many municipalities resist the use of HDPE for sanitary sewer applications; pipes constructed of materials other than HDPE are constantly presented to manufacturers of bursting equipment as that which the municipality would prefer to be the product pipe. Most often these pipes are of a segmented design, typically in 20′ lengths and constructed of either PVC (Poly Vinyl Chloride) or Ductile Iron. Currently, these pipes are occasionally installed using static pulling devices such as the HB5058 or by a method of pushing known in the industry as the ‘Tenbusch’ process (see Tenbusch U.S. Pat. Nos. 6,588,983; 6,039,505; 5,816,745; 5,482,404). This method, while commercially viable, has not been widely used despite the call for rehabilitation with segmented pipes.

In the case of the static pulling device, the process requires two substantial excavations, one for insertion of the product pipe, and one for the pulling device. This method is reasonable and appropriate for potable water as the piping system has no ready made excavations or even moderately sized access points. Sewer, either storm or sanitary is fortunate to have manholes placed at regular intervals, usually less than 500′ apart. These access points exist to facilitate cleaning, inspection and in the case of the MEw/oE process, the rehabilitation of the system.

State of the art equipment designed for the MEw/oE process will have a relatively short (on the order of 2′ long) burst head, a pneumatic tool with a diameter that slides freely within the inside diameter of the product pipe, and a reverse mechanism that allows remote disengagement of the tool from the burst head. A hydraulic winch is used to tow and guide the system through the host pipe. This winch normally applies 8 to 20 tons of pulling force. Upon completion of the burst, the tool is disengaged from the burst head using reverse operation, it's then withdrawn through the product pipe and the short burst head retrieved through the manhole. This process has become the norm, being used in over 50% of the applications where a manhole exists.

Unfortunately until now, the process has been limited to the installation of HDPE pipe only, or in some rare cases lightweight segmented pipe towed by a cable or rope behind the pneumatic tool for short distances. With many municipalities demanding that heavy ductile iron segmented pipe be used, the pipe bursting process has not gained favor as widely as one would believe given its economical nature and minimized disruption when compared to traditional excavation techniques for dig and replace rehabilitation of existing pipe systems. It is the intent of this invention to show that with some added effort, the MEw/oE process taught by Wentworth can be enhanced to permit the installation of a special form of Ductile Iron Pipe (hereafter DIP) in a commercially viable manner that yields the minimized excavation permitted by MEw/oE.

American Ductile Iron Pipe has developed a style of DIP intended for sanitary sewer rehabilitation using the Tenbusch process. It's primary feature is it's ability to be pushed with a column load and have minimal deflection and no damage to the seal or joint between segments (see http://www.acipco.com/adip/trenchless/gsmtpush.cfm#gs). This pipe is known as MT Push Pipe, it has no bells or enlarged areas at the joint. In addition the joints maintain alignment and allow thrust loading during installation. While originally intended for the Tenbusch process, we have seen that it can be readily applied to the MEw/oE process and its pneumatic impact tool. In the enhanced MEw/oE process, the pneumatic tool is used only to burst the host pipe and expand the surrounding soil while simultaneously towing a short sleeve of HDPE. This sleeve, 4 to 8′ in length, is sized relative to the DIP product pipe such that the sleeve inside diameter fits over the DIP outside in a manner than allows the DIP and the sleeve to slide axially in the manner of a trombone slide.

### SUMMARY OF THE INVENTION

A method according to the invention for installing an underground pipe uses a ground piercing tool having an elongated tubular tool body, a striker disposed for reciprocation within an internal chamber of the body to impart impacts to an impact surface for driving the tool forwardly through the ground, and an expander having a diameter greater than that of the tool body. The method includes the steps of:
securing a tubular shroud to the expander so that the ground piercing tool is disposed inside of the shroud;
operating the tool in forward mode over a run so that the impact tool and shroud move forward;
fitting a front end of a replacement pipe into sliding engagement with a rear end of the shroud; and
pushing the replacement pipe from a rear end portion thereof in a manner sufficient to insure that a front end of the replacement pipe remains in sliding contact with the shroud as the tool moves forward.

The method of the invention involves starting the burst process in a conventional manner, with the exception that the HDPE sleeve as described is used in place of the HDPE product pipe. Once the pneumatic tool, burst head and sleeve have entered the host pipe sufficiently far that it is convenient to start ‘insertion’ of the DIP product, the process departs from the original MEw/oE method. The insertion pit is enhanced from the original method in that a product pipe pushing device is added. The manner of placement is similar to Tenbusch, however the intent differs. Tenbusch teaches that a burst head is mounted to the front of the DIP product and that the bursting process and ground expansion is achieved by thrusting of the DIP with the pushing device. As an example, the common 8″ size pipe may require a peak pushing force of 100 tons to complete a reasonable installation length of 300′.

In the case of using a pneumatic tool for the MEw/oE process, 8 tons of pull on the burst head is typically used. It is estimated that the thrust forces required to install the DIP behind the pneumatic tool will be in the range of 15 tons. The purpose of the thrust force, unlike the Tenbusch method, is only to move the DIP product and ‘chase’ the burst head and tool as it moves through the host pipe.

This thrust force might be supplied by a device such as the McLaughlin McL-24B auger boring machine (see http://www.mightymole.com/prod04.htm). While this unit is overly capable in that it has 57.5 tons of thrust available and is also capable to rotating a high torque auger flighting, it does demonstrate existing devices that are adaptable for the new application. At a later date it would be prudent to design a small pusher powered by an air over hydraulic pump that is capable of 30 tons of thrust and operates on the same sort of tracks that the McLaughlin auger bore machines use.

As the first 20′ length of DIP product pipe is set in place, it is slid inside the HDPE sleeve and over the body of the pneumatic tool. It is moved forward until it bumps against the inside of the burst head. The opposite, or rear end of the pipe is set in a cradle mounted on the thrust unit frame. Force will be applied to the rear face of the pipe with a flat surface in the manner it is intended by the pipe manufacturer, though in a magnitude lower than originally designed for.

The repeated step of operating the tool to progress through the host pipe and moving the DIP product by operation of the thrusting device must be coordinated. If there is a level of heightened skill required over the original MEw/oE process, it is here. The thrust device, due to its hydraulic nature, will have a slow travel rate, on the order of two feet per minute. Pneumatic tools performing bursting may travel at rates from one to 20 foot per minute depending on condition of the surrounding soil and size of the burst head relative to the host pipe. It may require the operator to throttle the tool such that it moves at a rate that the thrust device can keep up. It is not important that the DIP product be pushed against the inside surface of the burst head throughout the process, however the distance that the product pipe can fall behind the head is limited to the length of the HDPE sleeve. Should the pneumatic tool be allowed to get far enough in front of the DIP product that the nose of the product pipe disengages from the sleeve, it is unlikely that the burst will be able to continue.

For this reason, the operator of the burst tool and the operator of the thrust device must be in constant contact so that the tool may be slowed or stopped as needed. When the DIP is thrust against the burst head, the operating frequency of the impact tool will be transmitted through the DIP, back to the insertion pit in the form of noise. When the DIP is not thrust against the burst head, this cadence will be lost, indicating the pneumatic tool must be slowed. In addition, when the 20′ section of pipe has traveled through the length of the insertion pit, the thrust machine must be reversed through this length to allow another section of DIP to be set in place for installation. During this time, it is necessary to either shut down the pneumatic tool completely or throttle it down to an idle mode where the system does not make forward progress through the host pipe.

Design of a custom pushing machine with fast travel and short length can be seen as a priority for this process to become efficient. Limiting thrust to 30 tons and powering it with the same air compressor used to actuate the pneumatic impact tool is very prudent. This set of operations is repeated for as many DIP sections as it takes to reach the target manhole. It is at this manhole where the hydraulic winch is located and where the burst head will be extracted. Upon emergence of the nose of the burst head into the manhole cavity, the pipe pushing process is stopped temporarily. The lower unit of the winch is raised slightly to allow the burst head complete entry into the manhole. The tool is started and the burst head, tool and sleeve are moved an additional 2 feet to allow the burst head to move far enough to expose the HDPE sleeve in the manhole. The pneumatic tool is shifted into reverse operation to disengage it from the locking burst head taper.

At this point two operations may be carried on simultaneously. The lower unit of the winch is removed from the manhole, preferably by using the labor saving method allowed by the design taught in Wentworth et al. U.S. Ser. No. 10/666,592, filed Sep. 19, 2003. The HDPE sleeve is sawed off just behind the burst head, leaving nearly it's entire length in the ground adjacent to the manhole wall. The burst head is then lifted from the manhole to clear the manhole of all apparatus. Note that abandoning of the sleeve differs from the original teachings of the MEw/oE method.

At the insertion pit, the pneumatic tool can be with drawn by pulling on the air supply hose either while the tool is off, or while it cycles at low power to help it break friction between it's body and the DIP product pipe. Alternately, the hydraulic thrust device can be used in the reverse direction to tow the tool from the DIP. Finally, when the tool has been cleared from the pipe and personnel have been evacuated from the manhole. The thrust machine can be used to move the Dip another two or three feet so that the end of the DIP is located at a distance appropriate for sealing its outside surface to the manhole wall.

In this method, it can be seen that there was no excavation at the manhole, only a small amount of work in the manhole to grout the opening created by the burst head. When manholes are located at busy urban intersections (a very common placement for a manhole), the adjacent pipes can now be replaced with stout, desirable DIP. Using the enhanced MEw/oE process with no excavation at the manhole, the insertion pit can be placed strategically somewhere mid block, minimizing impedance of traffic flow. Minimizing the total amount of excavation and all with a method that has been is widely accepted for use with HDPE product pipe. This revised method allows an alternate pipe style to be used with a small incremental amount of effort in the insertion pit.

### DETAILED DESCRIPTION

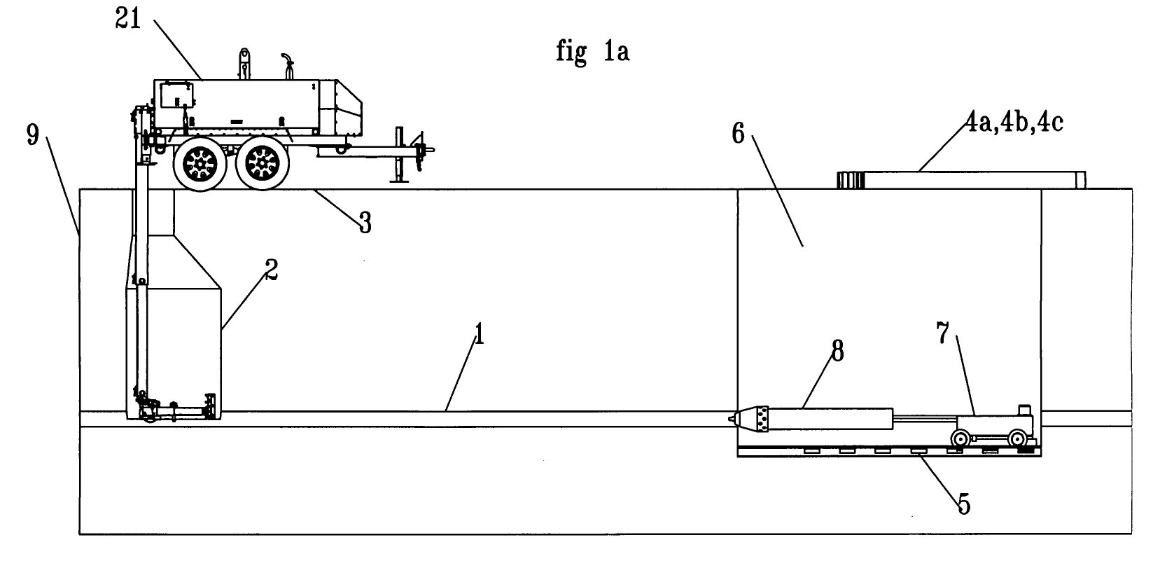

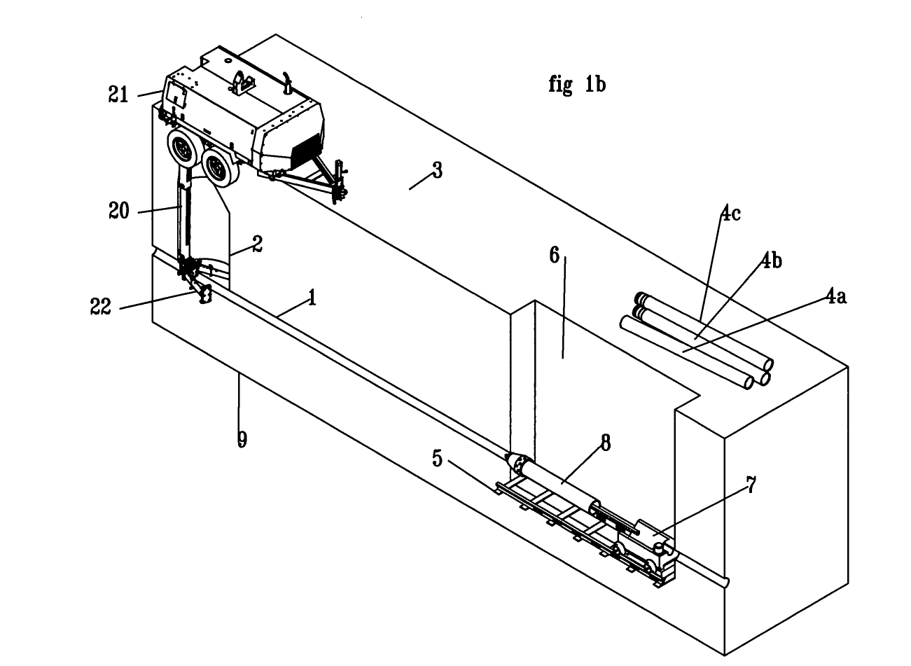

FIG. 1b shows an isometric overhead view of a jobsite. An existing pipeline 1, 8 inches in diameter runs 10 feet below the ground surface 3. The soil mass 9 surrounding the system which is rectangular in shape for illustration is actually infinite in all directions other than up. This pipeline 1 exists to conduct sanitary sewer flow to and through access manhole 2. Pipeline 1 should be assumed as needing replacement due to its age and state of decay. Excavation 6 is an insertion pit just over 13 feet long. It is shown abnormally close to manhole 2. Shown with just 25 feet between pit 6 and manhole 2 for clarity in this illustration, a more typical distance would be 100 to 500 feet.

Further, the jobsite shown in FIG. 1b is sectioned vertically along a plane that bisects the center of the existing or host pipe 1. Pipes 4a, 4b and 4c are setting on the ground surface adjacent to the insertion pit 6, note that pipes 4b and 4c have genders such that they can be connected end for end. Pipe 4a has the lead end cut off. The bottom of the insertion pit is occupied by auger bore tracks 5, pushing device 7 and a pneumatic impact assembly 8. In later figures the process of installing pipes 4a, 4b and 4c will be demonstrated. Winch 21 is parked over manhole 2 positioning it in such a manner as to allow mast 20 to extend down into manhole 20. Lower unit 22 contains a sheave (not shown) that allows a wire rope to extend through the length of pipe 1.

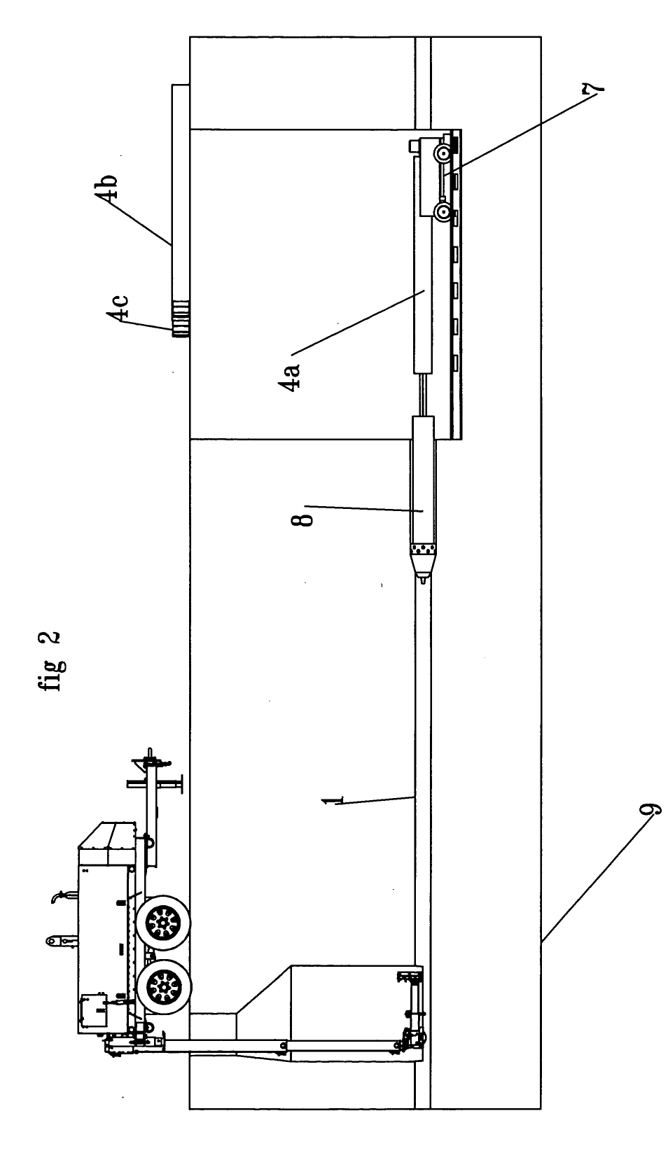

FIG. 1a shows all the same components of FIG. 1b; however the view is from the side. Both FIGS. 1a and 1b are displaying the status of the various components at the start of the job. FIG. 2 shows the pneumatic impact assembly 8 having traveled forward a short distance into the host pipe 1. The distance traveled is great enough to make it possible to set pipe 4a into position on pushing device 7. At this point pneumatic impact assembly 8 would be stopped or throttled down to stop progress through host pipe 1. Pipe 4a is placed so that the sawed off end will be nearest to impact assembly 8.

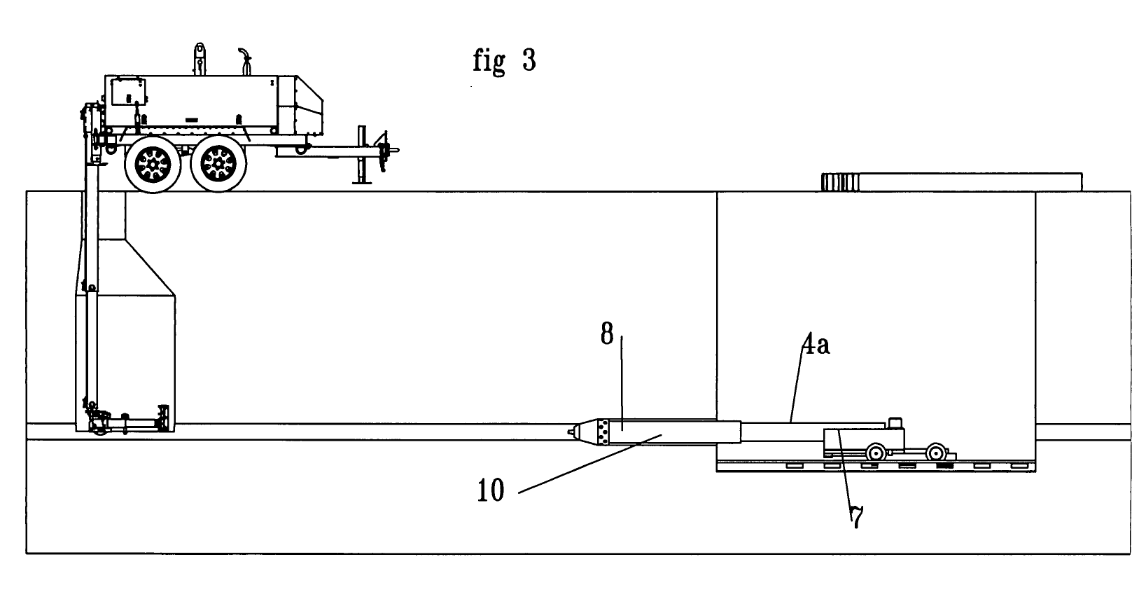

In FIG. 3, no incremental travel of pneumatic impact assembly 8 is apparent. Pipe 4a has been moved inside the HDPE shroud 10 by actuating pipe pushing device 7. Once the pipe is well within shroud 10, the pneumatic impact assembly 8 may be restarted.

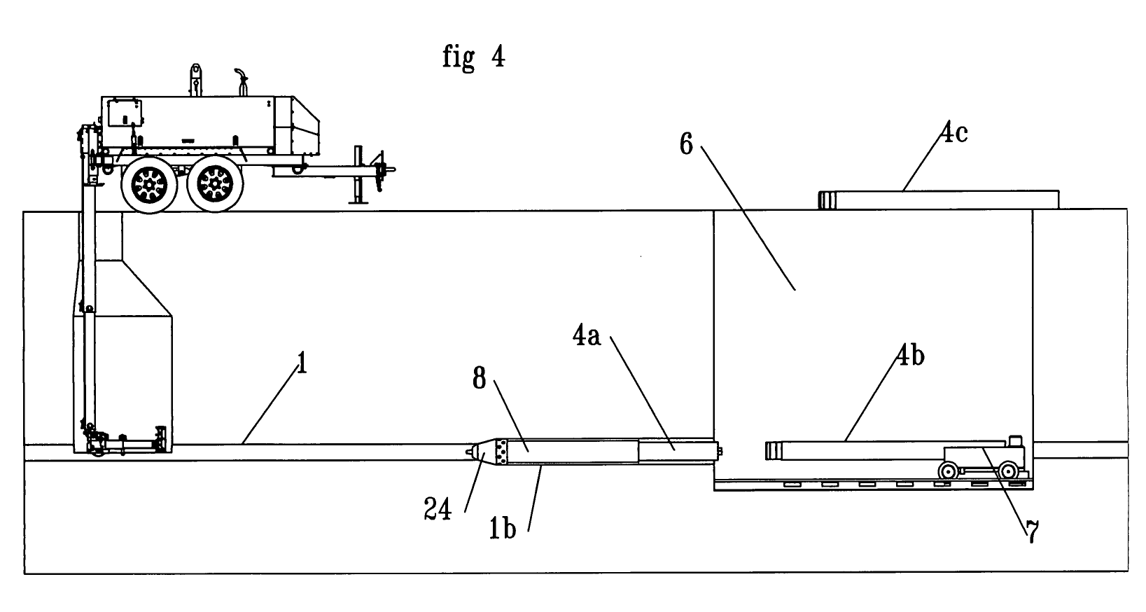

FIG. 4 demonstrates incremental travel of pneumatic impact assembly 8 and pipe 4a. Note that previous to the time snapshot given in FIG. 4, while impact assembly 8 traveled forward through the host pipe, pusher 7 moved pipe 4a forward along with the impact tool. In FIG. 4, pusher 7 has been drawn back and product pipe 4b has been lowered into the insertion pit 6 and the gendered ends of pipe 4a and 4b are about to be joined by moving pusher 7. Expanded bore 1b shows the effect of the burst head 24 passing through host pipe 1. The impact tool 12 (not shown) has thrust burst head 24 through the host pipe, cracking that pipe and expanding the surrounding soil in order to leave clearance for shroud 10. If necessary, pipe sections 4a, 4b are welded together at the joint in the launch pit before the replacement pipe is pushed further into the bore.

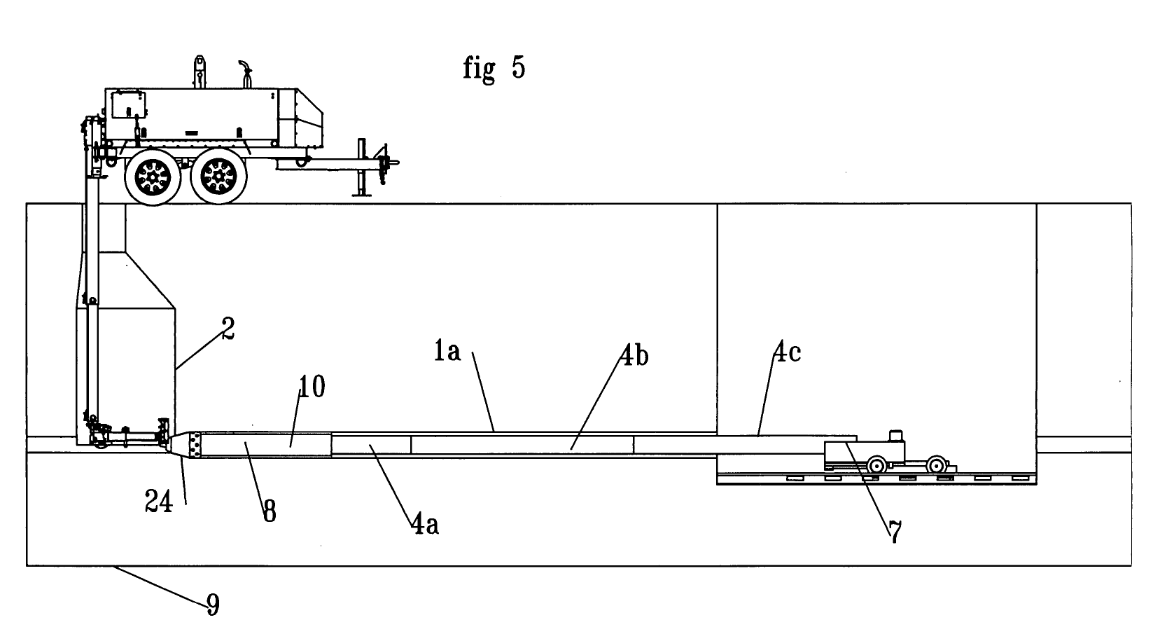

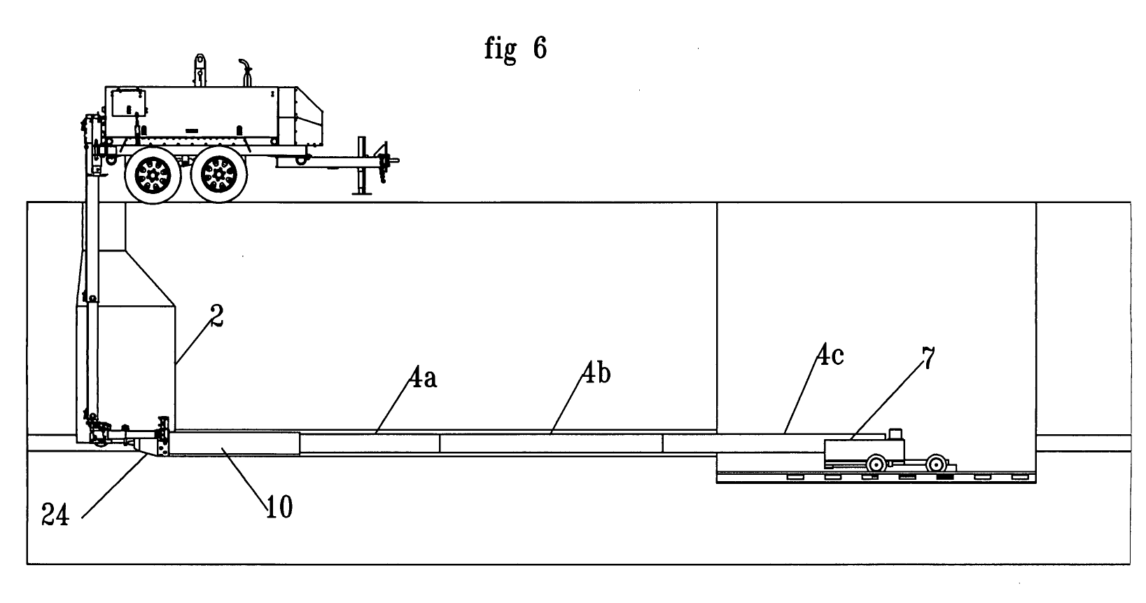

In FIG. 5, the pneumatic impact assembly 8 has traversed the length of host pipe 1, leaving the entire bore expanded as shown by 1a. All three product pipe sections 4a, 4b and 4c have been placed end to end with the gendered ends engaged. These sections of product pipe are moved forward in the shroud 10 as far as burst head 24 allows. Burst head 24 has progressed just far enough so the nose has entered the manhole 2. By the point in the method at which FIG. 6 is representative, the product pipe 4a-c is installed. Now pneumatic impact device 8 is inched forward while the pusher 7 is not moved. Upon reaching this position, the HDPE shroud 10 should be sawed off just behind the burst head 24. This is possible because the ductile iron product pipe 4a has is no longer directly behind the burst head 24, rather there is a space between them into which a saw blade can be inserted to separate burst head 24 and shroud 10. Alternately, burst head 24 can be disassembled from shroud 10 by removal of bolts securing the head to the shroud.

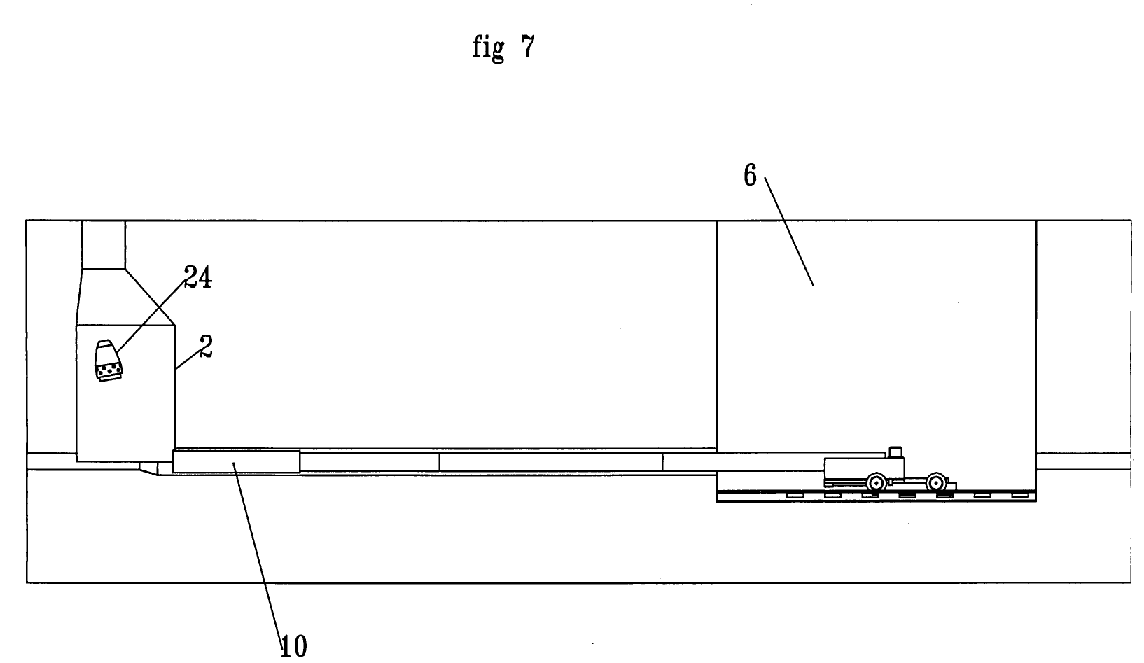

In FIG. 7, winch 21, associated mast 20 and lower unit 22 have been removed from the vicinity of manhole 2. Burst head 24, since sawed off shroud 10 is being extracted from manhole 2 by lifting it out using any convenient means. No movement of pipes 4a-c occurs at this time.

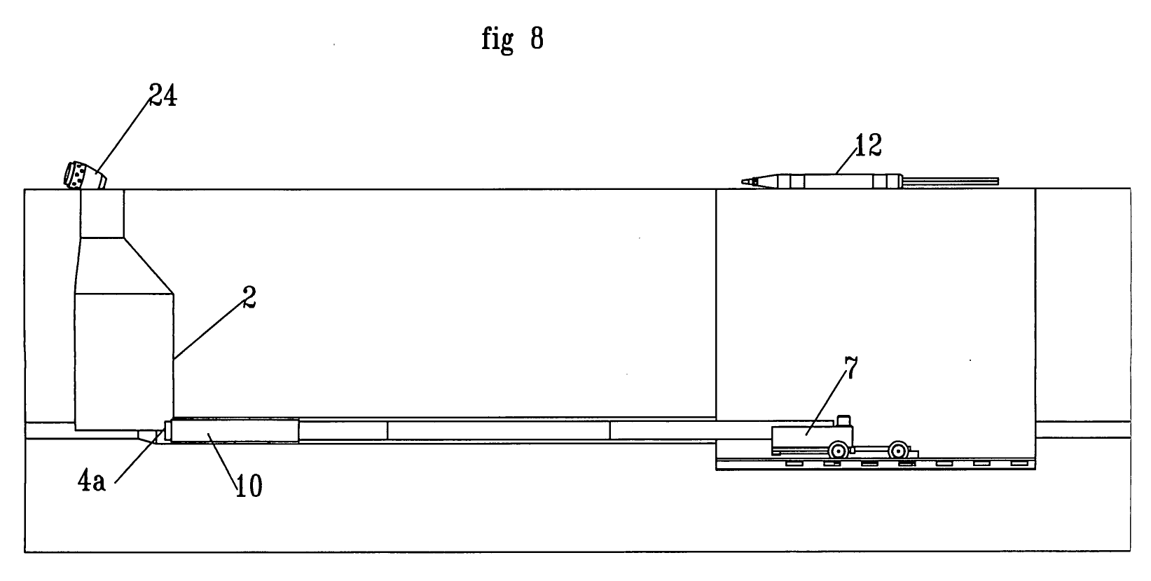

FIG. 8 shows pneumatic impact device 12 resting on the surface adjacent to insertion pit 6. This has been accomplished by pulling tool 12 through the inside of newly installed product pipes 4a-c. Additionally, after tool 12 is extracted from pipes 4a-c, said pipe string is thrust forward incrementally to extend the lead end of pipe 4a into manhole 2 in preparation for grouting. At this point, all equipment may be removed from insertion pit 6, allowing connections of the product pipe to the existing host pipe. Should it be desired, pusher 7 can be turned around and the entire process repeated in the other direction from that illustrated.

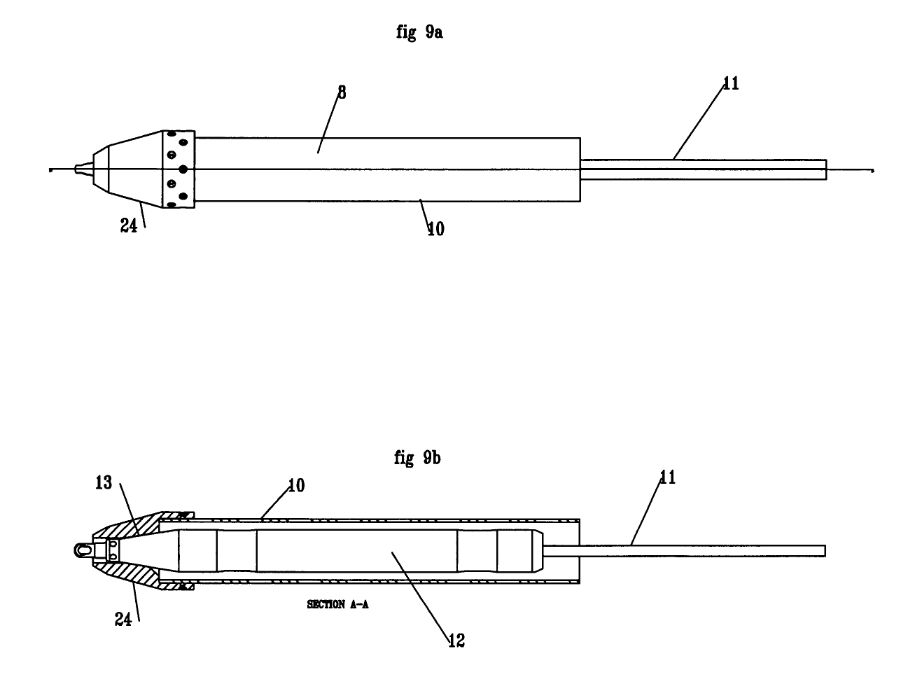

FIG. 9a shows an external view of pneumatic impact assembly 8. Visible are HDPE shroud 10 and burst head 24. FIG. 9b is a section view of 9a which exposes the pneumatic impact tool 12 and shows a locking taper angle 13 that produces the interface between tool 12 and burst head 24. This tapered surface transmits impact energy from the tool 12 to burst head 24 so that the impact can crack host pipe 1 and expand the surrounding soil. Note that twin air hose 11 is foreshortened in all figures for clarity. Air hose 11 must run through the interior of all product pipe that is being thrust by pusher 7 to follow impact assembly 8.

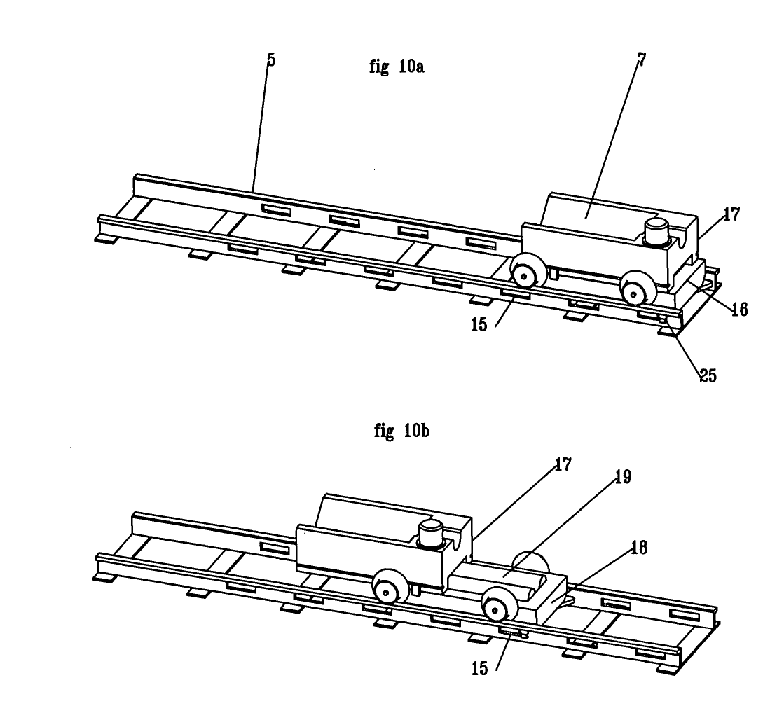

FIG. 10a is a detail of the pusher mounted on track set 5. These tracks have cutouts 15 at regularly spaced intervals. These cutouts are occupied by dogs 25 to allow thrust to be applied to the track set 5 by pusher 7. Pusher cradle 17 is slidably attached to pusher base 16. Thrust is applied by cylinders 19 between cradle 17 and base 18 to extend cradle 17 when dogs 15 are engaged. Dogs 15 may be engagable automatically using a mechanism, or set manually.

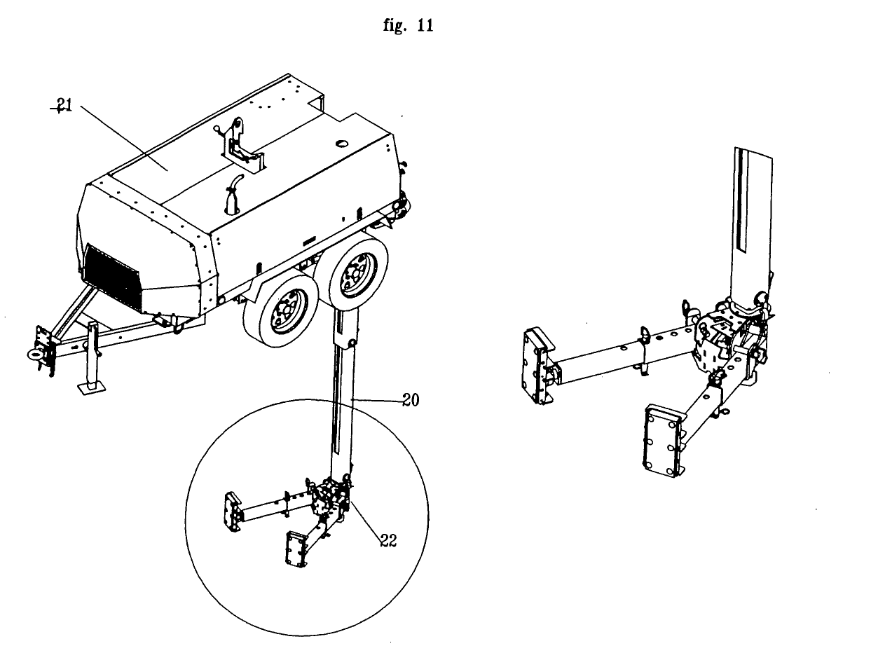

FIG. 11 shows a novel design for a constant tension winch. This winch, self powered by a diesel engine actuating a hydraulic pump and motor, exists to tow the pneumatic impact assembly through a host pipe. It is well known in the industry and is configured for optimal use in a sewer manhole. This unit is designed to facilitate MEw/oE when installing HDPE product pipe. It carries 2000 feet of ⅝″ diameter wire rope and can apply up to 12 tons of tensile force via the wire rope. Mast 20 pivots hydraulically for easy deployment and telescopes to reach host pipes up to 18 foot in depth. Lower unit 22 is a structural member to react the tensile force of the wire rope against the manhole wall. It also employs a sheave to turn the wire rope direction from vertical to horizontal so that it may be passed through the host pipe. For further details see commonly-owned Wentworth et al. U.S. Ser. No. 10/666,592, filed Sep. 19, 2003, the contents of which are incorporated herein by reference. This winch is well suited for use in the invention but use of other commercially available down hole winches, or no winch at all, is within the scope of the invention.

The invention thus provides a method of simultaneously bursting a host pipe and thrusting a segmented product pipe behind an impact device where a shroud attached to the impact device serves to maintain alignment of the product pipe to the impact device. Upon reaching a pre-existing aperture, the burst head is disengaged from the impact tool by reverse operation of the tool and the impact tool is withdrawn from the product pipe at the opposite end of the product pipe and the burst head is extracted through the pre-existing aperture. The shroud, generally 1-8 feet in length, is then separated from the burst head and left to remain permanently around the product pipe. The thrust device may be actuated by an air powered hydraulic system using hydraulic cylinders to impart thrust from a position along a track system, or man be mechanically operated. Any pipe pushing device known in the art may be used in lieu of the one illustrated here, such as a conventional pipe pushing machine or the arm of an excavator (e.g. backhoe) that reaches into the entry hole and pushes the replacement pipe ahead as needed.

Although various embodiments of the invention have been illustrated in the accompanying drawings and described in the foregoing detailed description, it will be understood that the invention is not limited to the embodiments disclosed but, as will be appreciated by those skilled in the art, is susceptible to numerous modifications and variations without departing from the spirit and scope of the invention as hereinafter claimed. For example, the replacement pipe could be of a continuous variety pushed by a mechanism which engages the pipeline on its sides. The method of the invention can be used to make new bores (no existing pipe.) The expander and impact tool may be separate or a single unit, and impactors other than pneumatic ones may be employed.

1. A method for installing an underground pipe using a ground piercing tool having an elongated tubular tool body, a striker disposed for reciprocation within an internal chamber of the body to impart impacts to an impact surface for driving the tool forwardly through the ground, and an expander having a diameter greater than that of the tool body, comprising the steps of:
securing a tubular shroud to the expander so that the ground piercing tool is disposed inside of the shroud;
operating the tool in forward mode over a run so that the impact tool and shroud move forward;
fitting a front end of a replacement pipe into sliding engagement with a rear end of the shroud; and
pushing the replacement pipe from a rear end portion thereof in a manner sufficient to insure that a front end of the replacement pipe remains in sliding contact with the shroud as the tool moves forward.

2. The method of claim 1, wherein a front end portion of the replacement pipe is slidingly received inside the shroud.

3. The method of claim 1, wherein the impact tool bursts an existing pipeline during the run.

4. The method of claim 3, further comprising:
when the tool has reached a receiving pit at the end of the run, removing the nose of the tool from the expander and disconnecting the expander from the pipe; and
removing the ground piercing tool from the pipe by moving it in a rearward direction through the newly installed pipe.

5. The method of claim 4, wherein the receiving pit comprises a manhole.
